(19) United States
(12) Patent Application Publication
(10) Pub. No.: US 2024/0176848 A1
(43) Pub. Date: May 30, 2024

(54) INFORMATION PROCESSING DEVICE, INFORMATION PROCESSING METHOD, AND STORAGE MEDIUM STORING PROGRAM

(71) Applicant: TOYOTA JIDOSHA KABUSHIKI KAISHA, Toyota-shi (JP)

(72) Inventors: Kazuto IDE, Gotemba-shi (JP); Hiroyuki KIMOTO, Susono-shi (JP)

(73) Assignee: TOYOTA JIDOSHA KABUSHIKI KAISHA, Toyota-shi (JP)

(21) Appl. No.: 18/486,503

(22) Filed: Oct. 13, 2023

(30) Foreign Application Priority Data
Nov. 25, 2022 (JP) 2022-188743

(51) Int. Cl. G06F 17/18

(52) U.S. Cl. CPC G06F 17/18

(57) ABSTRACT

An information processing device includes a first evaluation section that performs regression analysis for plural types of material sample based on first data including plural explanatory variables that are feature values and an objective variable that is a performance by regression analysis for respective combinations explanatory variables and that also evaluates error with respect to the regression analysis result, a second evaluation section that performs regression analysis for respective combinations of explanatory variables based on second data resulting from modifying a value of the objective variable in the first data and that also evaluates error with respect to a result of the regression analysis on the combination, a generation section that generates a distribution expressing a frequency of combinations of the explanatory variables with respect to the regression analysis result with the first data and that generates a distribution expressing a frequency of combinations of the explanatory variables resulting in respective errors for each of the errors with respect to the regression analysis result with the second data, and an output section that outputs a result of comparing the distributions.

### CROSS-REFERENCE TO RELATED APPLICATION

This application is based on and claims priority under 35 USC 119 from Japanese Patent Application No. 2022-188743 filed on Nov. 25, 2022, the disclosure of which is incorporated by reference herein.

### BACKGROUND

### Technical Field

The present disclosure relates to an information processing device, an information processing method, and a storage medium storing a program.

### Related Art

JP-A No. 2022-14618 discloses a prediction device that visualizes whether a predicted value can be trusted as a reliability index. This prediction device includes an input section for inputting explanatory variables and a permissible error, a regression prediction model database for storing a regression prediction model, a quantile regression model database for storing a quantile regression model, a prediction section that predicts an objective variable based on the explanatory variables and the regression prediction model, and a reliability computation section. The reliability computation section predicts a prediction quantile value based on the explanatory variables and the quantile regression model, computes a permissible error range from the objective variable and the permissible error, and computes a reliability of the predicted objective variable from a relationship between the permissible error range and the prediction quantile value.

The prediction device of JP-A No. 2022-14618 does not consider evaluation of the significance of the regression model. Moreover, there is a demand to evaluate the significance of the results of each regression analysis in cases in which regression analysis is performed for respective combinations of at least one explanatory variable from among the plural explanatory variables.

### SUMMARY

An object of the present disclosure is to evaluate the significance of regression analysis results of material sample data for respective combinations of explanatory variables.

An information processing device includes a first evaluation section, a second evaluation section, a generation section, and an output section. The first evaluation section performs regression analysis for plural types of material sample based on first data including plural explanatory variables that are feature values of the material sample and an objective variable that is a performance of the material sample by performing regression analysis for respective combinations of at least one explanatory variable from among the plural explanatory variables, and also evaluates error with respect to a result of the regression analysis on the combination. The second evaluation section performs regression analysis for respective combinations of at least one explanatory variable from among the plural explanatory variables based on second data that results from modifying a value of the objective variable in the first data for the plural types of material sample, and also evaluates error with respect to a result of the regression analysis on the combination. The generation section generates a distribution expressing a frequency of combinations of the explanatory variables resulting in respective errors for each of the errors based on the evaluation result of the error with respect to the regression analysis result with the first data, and generates a distribution expressing a frequency of combinations of the explanatory variables resulting in respective errors for each of the errors based on the evaluation result of the error with respect to the regression analysis result with the second data. The output section outputs a result of comparing the distributions.

In the information processing device according to the first aspect, the first evaluation section performs regression analysis for plural types of material sample based on first data including plural explanatory variables that are feature values of the material sample and an objective variable that is a performance of the material sample by performing regression analysis for respective combinations of at least one explanatory variable from among the plural explanatory variables, and also evaluates error with respect to a result of the regression analysis on the combination. Reference here to “regression analysis” means finding regression coefficients for each explanatory variable when a value of the objective variable is expressed in terms of values of the explanatory variables. Reference here to “error with respect to a result of regression analysis” means an error between an objective variable value as estimated from the explanatory variable values and the regression coefficients of each of the explanatory variables, and the actual value of the objective variable.

The second evaluation section performs regression analysis for the respective combinations of at least one explanatory variable from among the plural explanatory variables based on the second data that results from modifying the objective variable value in the first data for the plural types of material sample, and also evaluates error with respect to the regression analysis result for the combination.

The generation section generates the distribution expressing the frequency of combinations of the explanatory variables resulting in respective errors for each of the errors based on the evaluation result of the error with respect to the regression analysis result with the first data, and generates the distribution expressing the frequency of combinations of the explanatory variables resulting in respective errors for each of the errors based on the evaluation result of the error with respect to the regression analysis result with the second data. The output section outputs the result of comparing the distributions. This thereby enables the significance of the regression analysis results of the material sample data to be evaluated for each explanatory variable combination.

An information processing device according to the second aspect is the information processing device according to the first aspect, further including a determination section that determines a significance of the regression analysis result with the first data based on a result of comparing the distributions, and a visualization section that visualizes a magnitude of regression coefficients for each of the explanatory variables obtained as the regression analysis result for each explanatory variable combination in a case in which the regression analysis result with the first data is determined to be significant.

In the information processing device according to the second aspect, the determination section determines the significance of the regression analysis result with the first data based on the result of comparing the distributions. The visualization section visualizes the magnitude of the regression coefficients for each of the explanatory variables obtained as the regression analysis result for each explanatory variable combination in a case in which the regression analysis result with the first data are determined to be significant. This thereby enables the user to ascertain the explanatory variables having larger regression coefficients in the regression analysis results for each explanatory variable combination.

An information processing device according to a third aspect is the information processing device according to the second aspect, further including a reception section that receives a selection of at least one explanatory variable, and the first evaluation section further performs regression analysis for the selected combination of at least one explanatory variable and evaluates error with respect to a result of the regression analysis result for the selected combination.

In the information processing device according to the third aspect, the reception section receives selection of the at least one explanatory variable. The first evaluation section then perform regression analysis on the selected combination of the one or more explanatory variable, and evaluates errors with respect to the result of regression analysis for the combination. This thereby enables regression analysis to be performed on a desired explanatory variable combination, facilitating feature selection.

A fourth aspect is an information processing method that performs regression analysis for plural types of material sample based on first data including plural explanatory variables that are feature values of the material sample and an objective variable that is a performance of the material sample by performing regression analysis for respective combinations of at least one explanatory variable from among the plural explanatory variables and also evaluates error with respect to a result of the regression analysis on the combination, that performs regression analysis for respective combinations of at least one explanatory variable from among the plural explanatory variables based on second data that results from modifying a value of the objective variable in the first data for the plural types of material sample and also evaluates error with respect to a result of regression analysis on the combination, that generates a distribution expressing a frequency of combinations of the explanatory variables resulting in respective errors for each of the errors based on the evaluation result of the error with respect to the regression analysis result with the first data, that generates a distribution expressing a frequency of combinations of the explanatory variables resulting in respective errors for each of the errors based on the evaluation result of the error with respect to the regression analysis result with the second data, and that outputs a result of comparing the distributions.

In the information processing method according to the fourth aspect, regression analysis is performed for the plural types of material sample based on the first data including the plural explanatory variables that are feature values of the material sample and the objective variable that is a performance of the material sample by performing regression analysis for respective combinations of at least one explanatory variable from among the plural explanatory variables, and the error with respect to the result of the regression analysis on the combination is also evaluated. Regression analysis is also performed for the respective combinations of at least one explanatory variable from among the plural explanatory variables based on the second data that results from modifying the value of the objective variable in the first data for the plural types of material sample, and error with respect to the result of regression analysis on the combination is also evaluated. The distribution expressing the frequency of combinations of the explanatory variables resulting in respective errors for each of the errors is generated based on the evaluation result of the error with respect to the regression analysis result with the first data, the distribution expressing the frequency of combinations of the explanatory variables resulting in respective errors for each of the errors is generated based on the evaluation result of the error with respect to the regression analysis result with the second data. The result of comparing the distributions is then output. This thereby enables the significance of the results of regression analysis of the material sample data to be evaluated for each explanatory variable combination.

A program stored on a non-transitory storage medium of a fifth aspect is a program that causes a computer to execute processing. The processing includes performing regression analysis for plural types of material sample based on first data including plural explanatory variables that are feature values of the material sample and an objective variable that is a performance of the material sample by performing regression analysis for respective combinations of at least one explanatory variable from among the plural explanatory variables and also evaluating error with respect to a result of the regression analysis on the combination, performing regression analysis for respective combinations of at least one explanatory variable from among the plural explanatory variables based on second data that results from modifying a value of the objective variable in the first data for the plural types of material sample and also evaluating error with respect to a result of regression analysis on the combination, generating a distribution expressing a frequency of combinations of the explanatory variables resulting in respective errors for each of the errors based on the evaluation result of the error with respect to the regression analysis result with the first data, generating a distribution expressing a frequency of combinations of the explanatory variables resulting in respective errors for each of the errors based on the evaluation result of the error with respect to the regression analysis result with the second data, and outputting a result of comparing the distributions.

With the program stored on the non-transitory storage medium of the fifth aspect, the computer performs regression analysis for plural types of material sample based on the first data including the plural explanatory variables that are feature values of the material sample and the objective variable that is a performance of the material sample by performing regression analysis for the respective combinations of at least one explanatory variable from among the plural explanatory variables and also evaluates the error with respect to the result of the regression analysis on the combination. The computer also performs regression analysis for the respective combinations of at least one explanatory variable from among the plural explanatory variables based on the second data that results from modifying the value of the objective variable in the first data for the plural types of material sample and also evaluates the error with respect to the result of regression analysis on the combination. The computer then generates the distribution expressing the frequency of combinations of the explanatory variables resulting in respective errors for each of the errors based on the evaluation result of the error with respect to the regression analysis result with the first data, and generates the distribution expressing the frequency of combinations of the explanatory variables resulting in respective errors for each of the errors based on the evaluation result of the error with respect to the regression analysis result with the second data. The computer then outputs the result of comparing the distributions. This thereby enables evaluation of the significance of regression analysis results of material sample data for respective combinations of explanatory variables.

The present disclosure as described above exhibits the excellent advantageous effect of enabling evaluation of the significance of regression analysis results of material sample data for respective combinations of explanatory variables.

### BRIEF DESCRIPTION OF THE DRAWINGS

Exemplary embodiments of the present disclosure will be described in detail based on the following figures, wherein:

FIG. 1 is a schematic block diagram of an information processing system according to an exemplary embodiment;

FIG. 2 is a diagram illustrating an example of a graph showing the frequency of combinations of explanatory variables that result in each error;

FIG. 3 is a diagram illustrating an example of a graph showing the frequency of combinations of explanatory variables that result in each error;

FIG. 4 is diagram illustrating an example of a visualization of magnitude of regression coefficients for each explanatory variable;

FIG. 5 is a diagram illustrating an example of a configuration of a computer of a cloud server and a user terminal according to an exemplary embodiment;

FIG. 6 is a flowchart illustrating an example of an information processing routine performed in an information processing device according to an exemplary embodiment; and

FIG. 7 is a flowchart illustrating an example of an information processing routine performed in an information processing device according to an exemplary embodiment.

### DETAILED DESCRIPTION

Description follows regarding an information processing system of an exemplary embodiment, with reference to the drawings.

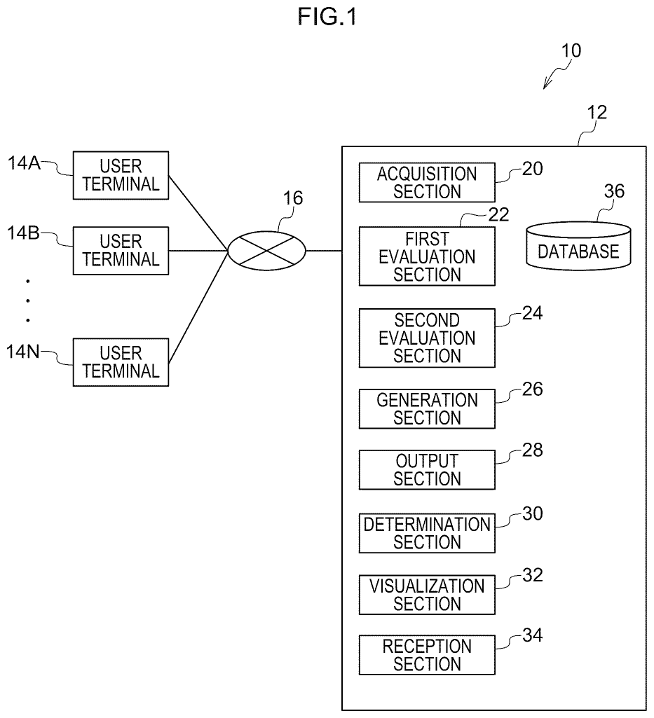

FIG. 1 is a block diagram illustrating an example of a functional configuration of an information processing system 10 according to an exemplary embodiment. The information processing system 10 includes, as illustrated in FIG. 1, plural user terminals 14A, 14B, . . . , 14N and a cloud server 12 serving as an example of an information processing device. The plural user terminals 14A, 14B, . . . , 14N and the cloud server 12 are, for example, connected together over a network 16, such as the internet. Note that a single user terminal referred to below will be called simply user terminal 14.

### User Terminal

Each of the user terminals 14A to 14N transmits measurement data related to a material sample measured using plural measurement methods to the cloud server 12.

Each of the plural user terminals 14A, 14B, . . . , 14N is operated by a different user of plural users.

The users each input measurement data related to an analysis target material sample to the user terminal 14 they themselves are operating. The measurement data related to the analysis target material sample includes, for example, data measured using a method such as X-ray diffraction, small angle X-ray scattering, or the like, data measured using a microscope, data measured using Raman spectrometry, and data measured using infrared spectrometry.

### Cloud Server

The cloud server 12 stores the measurement data of plural material samples, and for each of the plural material samples stores analysis data expressing analysis results of analyzing the material samples from the measurement data using an analysis method. For example, the material samples are analyzed from the measurement data using an analysis method on the measurement data such as an X-ray diffraction analysis method, a small angle X-ray scattering analysis method, a microscope image analysis method, a Raman spectrometry analysis method, or an infrared spectrometry analysis method.

The cloud server 12 performs regression analysis for plural types of material sample based on data obtained from the measurement data and analysis data that includes plural explanatory variables that are feature values of the material samples and includes an objective variable that is a performance of the material sample. This regression analysis is performed for respective combinations of at least one explanatory variable from among the plural explanatory variables and the cloud server 12 also evaluates the results of the regression analysis.

More specifically as illustrated in FIG. 1, the cloud server 12 includes functions of an acquisition section 20, a first evaluation section 22, a second evaluation section 24, a generation section 26, an output section 28, a determination section 30, a visualization section 32, a reception section 34, and a database 36.

The acquisition section 20 acquires measurement data from the plural user terminals 14A to 14N related to the plural material samples as measured by a measurement method, and stores this measurement data in the database 36. The acquisition section 20 analyzes the material sample from the measurement data using an analysis method, and stores analysis data expressing the analysis results in the database 36.

The acquisition section 20 acquires the first data for the plural types of material sample from the database 36, with the first data including the plural explanatory variables that are feature values of the material samples and including the objective variable that is the performance of the material sample.

More specifically, the acquisition section 20 acquires plural feature values and performance from the respective measurement data and the respective analysis data for the material samples as first data, in which the plural feature values are plural explanatory variables and the performance is the objective variable.

The acquisition section 20 acquires second data that results from modifying a value of the objective variable in the first data for the plural types of material sample. More specifically, for the plural types of material sample the acquisition section 20 acquires the second data, which includes plural explanatory variables that are feature values of the material samples and the objective variable that is the performance of the material sample, by switching values of the objective variable of the first data between material samples.

The first evaluation section 22 performs regression analysis on respective combinations of at least one explanatory variable from among the plural explanatory variables based on the first data for the plural types of material sample, and also evaluates error with respect to the result of regression analysis for the combination.

More specifically, the first evaluation section 22 performs regression analysis for the respective combinations of at least one explanatory variable from among the plural explanatory variables based on the first data for the plural types of material sample, and finds a regression coefficient for each of the explanatory variables when the objective variable value is expressed in terms of the explanatory variable values. Then based on the first data for the plural types of material sample, for respective combinations of at least one explanatory variable from among the plural explanatory variables the first evaluation section 22 evaluates errors with respect to the regression analysis results for respective combinations by finding an error between the value of the objective variable as estimated from the explanatory variable values and the regression coefficient for each of the explanatory variables obtained as the regression analysis result, and the actual value of the objective variable.

The second evaluation section 24, similarly to the first evaluation section 22, performs regression analysis for respective combinations of at least one explanatory variable from among the plural explanatory variables based on the second data for the plural types of material sample, and evaluates errors in the regression analysis result for the combination.

Based on the evaluation results of the errors with respect to the regression analysis results with the first data for the respective combinations of explanatory variables, the generation section 26 generates a distribution expressing a frequency of combinations of explanatory variables resulting in respective errors for each of the errors. Based on the evaluation results of the errors with respect to the regression analysis results with the second data for the respective combinations of explanatory variables, the generation section 26 generates a distribution expressing a frequency for each error of combinations of explanatory variables resulting in each error.

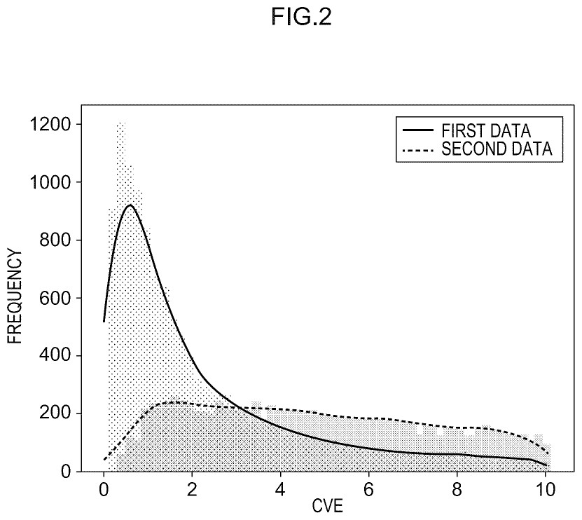

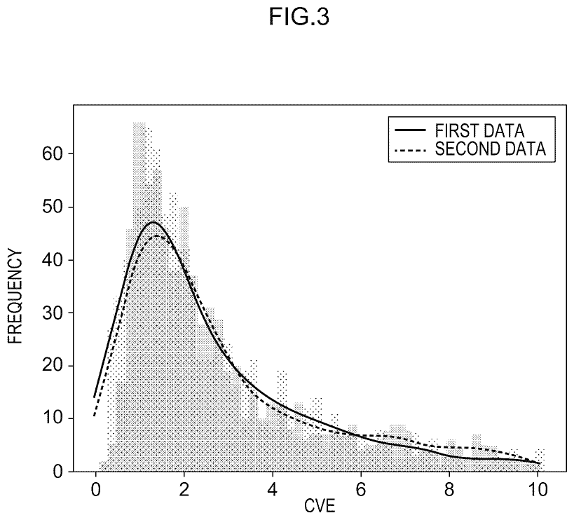

As illustrated in FIG. 2 and FIG. 3, the output section 28 generates screens representing results of comparing the distributions, and displays these on the user terminal 14.

FIG. 2 and FIG. 3 are graphs expressing the frequency of explanatory variable combinations that result in respective cross validation errors (CVE) for each of the cross validation errors, and are examples in which results of the regression analysis with the first data and results of the regression analysis the second data are displayed so as to enable comparison therebetween.

FIG. 2 illustrates an example in which there are more explanatory variable combinations having a small cross validation error than the frequency of explanatory variable combinations having a large cross validation error in the regression analysis results for the first data. The example illustrated in FIG. 2 is an example in which the frequency of explanatory variable combinations having a large cross validation error is not very different from the frequency of explanatory variable combinations having a small cross validation error in the regression analysis results for the second data.

FIG. 3 illustrates an example in which there are more explanatory variable combinations having a small cross validation error than the frequency of explanatory variable combinations having a large cross validation error in the regression analysis results for the first data. The example illustrated in FIG. 3 is an example in which there are more explanatory variable combinations having a small cross validation error than the frequency of explanatory variable combinations having a large cross validation error in the regression analysis results for the second data. Namely, FIG. 3 is a graph expressing the frequency of explanatory variable combinations that result in respective cross validation errors for an example in which there is little difference between regression analysis results with the first data and regression analysis results with the second data.

The determination section 30 determines the significance of the regression analysis results with the first data based on the result of comparing the distributions. For example, absolute values of difference between the frequency of explanatory variable combinations resulting in each cross validation error are calculated between the regression analysis results of the first data and the regression analysis results of the second data. Then when the total of these absolute values of differences is a threshold or greater, this is determined as there being a difference between the generated distributions for the regression analysis results of the first data and the regression analysis results of the second data, and the regression analysis results with the first data are accordingly determined to be significant.

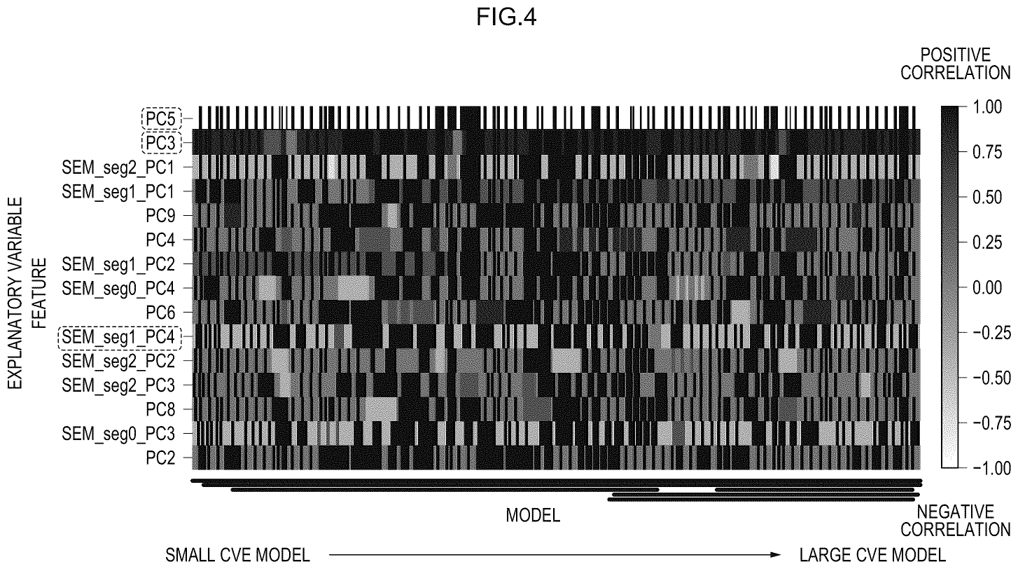

In cases in which the regression analysis results with the first data have been determined to be significant, the visualization section 32 generates a screen that, as illustrated in FIG. 4, visualizes a magnitude of the explanatory variable regression coefficients for each explanatory variable in respective combinations of explanatory variables as obtained in the results of regression analysis with the first data, and displays this screen on the user terminal 14.

FIG. 4 illustrates an example in which the magnitude of the explanatory variable regression coefficients for each of the explanatory variables in the respective explanatory variable combinations as obtained in the regression analysis results with the first data is visualized by different colors. Moreover, FIG. 4 illustrates regression analysis results for explanatory variable combinations for which the cross validation error is small further to the left side, and illustrates regression analysis results for explanatory variable combinations for which the cross validation error is large further to the right side. FIG. 4 illustrates an example of visualization in which the regression coefficients are colored differently so as to enable distinguishing between positive correlations and negative correlations.

The reception section 34 receives selection from the user terminal 14 of at least one explanatory variable on the screen where the magnitude of regression coefficients are being visualized. FIG. 4 illustrates an example in which three explanatory variables have been selected (see the three broken line boxes therein).

The first evaluation section 22 then performs regression analysis once again on the selected combination of at least one explanatory variable, evaluates an error with respect to the regression analysis results for this combination, and displays a screen expressing the error evaluation result on the user terminal 14.

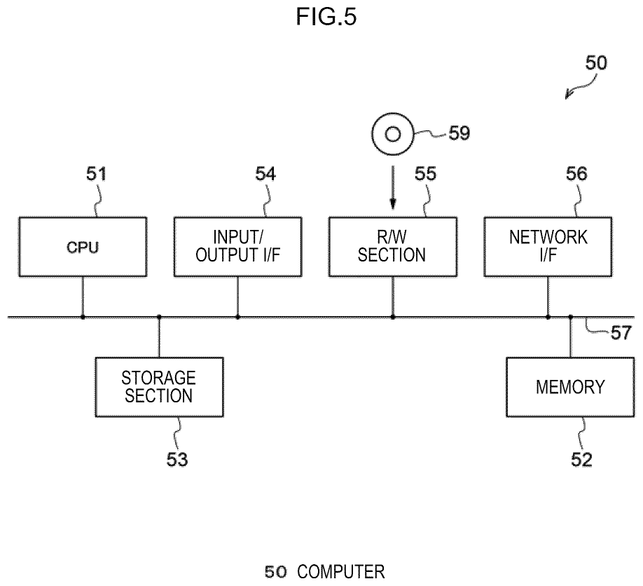

The user terminal 14 and the cloud server 12 may each, for example, be implemented by a computer 50 such as illustrated in FIG. 5. The computer 50 implementing the user terminal 14 and the cloud server 12 includes a CPU 51, a memory 52 serving as a temporary storage area, and a non-transitory storage section 53. The computer 50 includes an input/output interface (I/F) 54 connected to an input/output device or the like (omitted in the drawings), a read/write (R/W) section 55 that controls reading and writing of data to a recording medium 59. The computer 50 also includes a network I/F 56 that is connected to a network such as the internet. The CPU 51, the memory 52, the storage section 53, the input/output I/F 54, the R/W section 55, and the network I/F 56 are connected together through a bus 57. The CPU 51 serves as an example of a processor.

The storage section 53 may be implemented by a hard disk drive (HDD), solid state drive (SSD), flash memory, or the like. A program to cause a computer to function is stored on the storage section 53 serving as a storage medium. The CPU 51 reads the program from the storage section 53, expands the program in the memory 52, and sequentially executes processes included in the program.

Next, description follows regarding operation of the information processing system 10 of an exemplary embodiment.

When measurement data related to a material sample is input to the user terminal 14, the measurement data related to the material sample is transmitted to the cloud server 12. When the measurement data related to the material sample is transmitted from the user terminal 14 to the cloud server 12, the cloud server 12 stores the measurement data related to the material sample in the database 36. Measurement data related to plural material samples is thereby stored in the database 36.

For each of the plural material samples, the cloud server 12 uses an analysis method to analyze the material sample from the measurement data stored in the database 36, acquires analysis data expressing an analysis result, and stores the analysis result in the database 36.

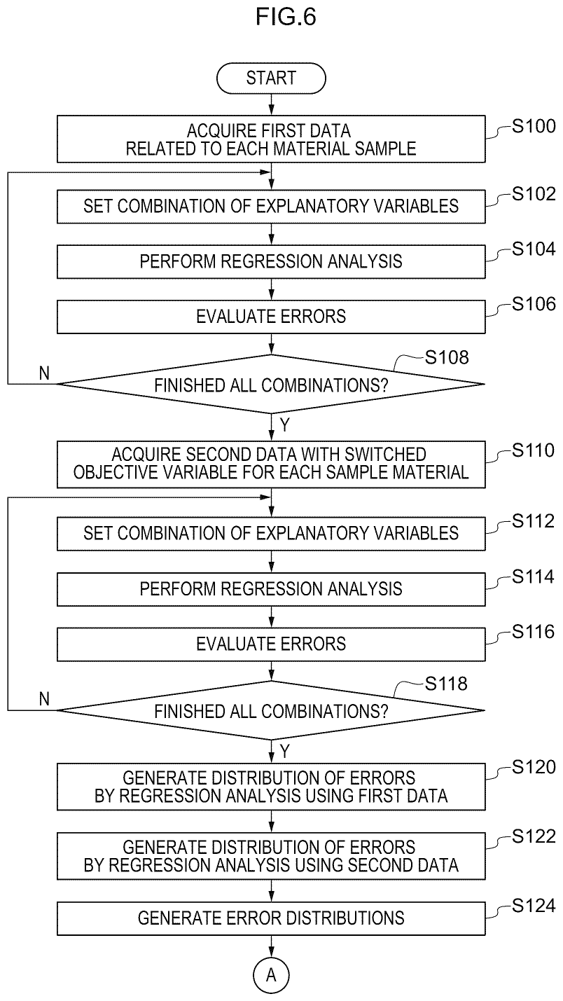

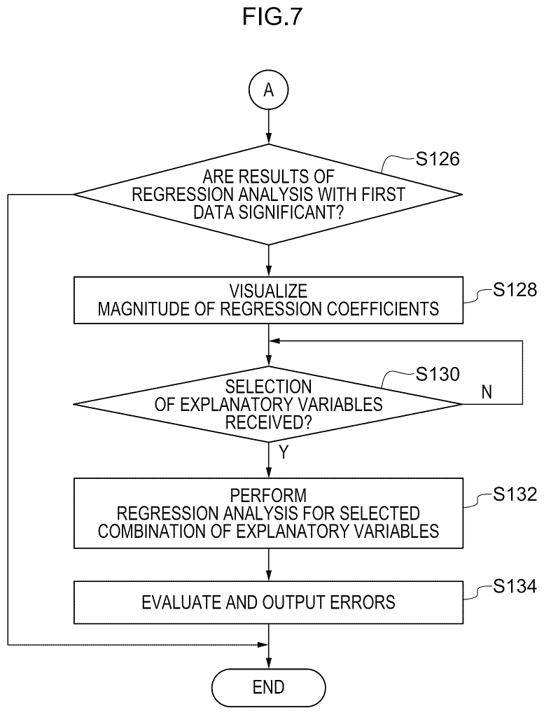

When a request to analyze material sample data is input to the user terminal 14, the material sample data analysis request is transmitted to the cloud server 12. The cloud server 12 then executes the information processing routine as illustrated in FIG. 6 and FIG. 7.

At step S100, the acquisition section 20 acquires, from the database 36, the first data for plural types of material sample, which includes the plural explanatory variables that are feature values of the material samples and the objective variable that is the performance of the material sample.

At step S102, the first evaluation section 22 sets one combination of at least one explanatory variable from among the plural explanatory variables as a processing target.

At step S104, for the plural types of material sample, the first evaluation section 22 performs regression analysis on the respective combination of explanatory variables that is the processing target based on the first data, which includes the plural explanatory variables that are feature values of the material samples and the objective variable that is the performance of the material sample.

At step S106, the first evaluation section 22 evaluates the error with respect to the regression analysis results for the combination of explanatory variables that is the processing target.

At step S108, the first evaluation section 22 determines whether or not the processing of steps S102 to S106 has been executed for all the respective combinations of explanatory variables. Processing returns to step S102 in cases in which the processing of steps S102 to S106 has not been executed for one of the explanatory variable combinations, and then this explanatory variable combination is set as the processing target. However, processing transitions to step S110 in cases in which the processing of steps S102 to S106 has been executed for all of the explanatory variable combinations.

At step S110, the acquisition section 20 acquires the second data for the plural types of material sample which result from modifying the value of the objective variable in the first data for the plural types of material sample.

At step S112, the second evaluation section 24 sets one of the combinations of at least one explanatory variable from among the plural explanatory variables as the processing target.

At step S114, the second evaluation section 24 performs regression analysis on the explanatory variable combination of the processing target based on the second data for the plural types of material sample.

At step S116, the second evaluation section 24 evaluates the error with respect to regression analysis results for the explanatory variable combination of the processing target.

At step S118, the second evaluation section 24 determines whether or not the processing of step S112 to step S116 has been executed for all the explanatory variable combinations. Processing returns to step S112 in cases in which the processing of steps S112 to S116 has not been executed for one of the explanatory variable combinations, and then this explanatory variable combination is set as the processing target. However, processing transitions to step S120 in cases in which the processing of steps S112 to S116 has been executed for all the explanatory variable combinations.

At step S120, the generation section 26 generates a distribution expressing a frequency of combinations of explanatory variables that result in respective errors for each of the errors based on the evaluation results for the first data.

At step S122, the generation section 26 generates a distribution expressing a frequency of combinations of explanatory variables that result in respective errors for each of the errors based on the evaluation results of error for the second data.

At step S124, the output section 28 outputs results of comparing the generated distributions.

At step S126, the determination section 30 determines whether or not the regression analysis results with the first data are significant based on the results of comparing the generated distributions. This information processing routine is ended in cases in which determination is that the regression analysis results for the first data are not significant. However, processing transitions to step S128 in cases in which determination is that the regression analysis results for the first data are significant.

At step S128, the visualization section 32 generates a screen that visualizes a magnitude of the explanatory variable regression coefficients for each explanatory variable obtained as the regression analysis results with the first data for the respective combinations of explanatory variables, and displays this screen on the user terminal 14.

The user looking at this screen then selects explanatory variables to employ when modeling the performance, which is the objective variable.

A step S130, the reception section 34 determines whether or not a selection of at least one explanatory variable has been received from the user terminal 14 on the screen visualizing the magnitude of regression coefficients. Processing transitions to step S132 in cases in which a selection of explanatory variables has been received from the user terminal 14.

At step S132, the first evaluation section 22 performs regression analysis for the selected combination of at least one explanatory variable.

At step S134, the first evaluation section 22 evaluates error with respect to regression analysis results for this combination, displays the evaluated result on the user terminal 14, and ends the information processing routine.

As described above, the cloud server of the information processing system according to an exemplary embodiment generates, for the plural types of material sample, a distribution expressing a frequency of combinations of the explanatory variables resulting in respective errors for each of the errors based on the evaluation result of the error with respect to the regression analysis result with the first data, which includes the plural explanatory variables that are feature values of the material samples and the objective variable that is the performance of the material sample, and generates a distribution expressing a frequency of combinations of the explanatory variables resulting in respective errors for each of the errors based on the evaluation result of the error with respect to the regression analysis result with the second data that results from modifying a value of the objective variable in the first data for the plural of types of material sample, and outputs the result of comparing the generated distributions. This thereby enables the significance of the regression analysis results with the material sample data to be evaluated for the respective explanatory variable combinations.

Moreover, the significance of the regression analysis result with the first data is determined based on a result of comparing the generated distributions, and the magnitude of regression coefficients for each of the explanatory variables obtained as the regression analysis result for each explanatory variable combination is visualized in a case in which the regression analysis result with the first data are determined to be significant. This thereby enables the user to ascertain which explanatory variables have large regression coefficients in the regression analysis results for the respective combinations of explanatory variables.

Moreover, a selection of at least one explanatory variable is received, and regression analysis is performed for the selected combination of at least one explanatory variable, and error with respect to a result of the regression analysis result is evaluated for the combination. This thereby enables regression analysis to be performed for a desired explanatory variable combination, facilitating feature selection.

Note that although a description has been given in which the processing performed by the respective devices of the exemplary embodiment described above is software processing performed by executing a program, this processing may be performed by hardware. Alternatively, the processing may performed by a combination of software and hardware. The program stored in ROM may be distributed in a format stored on various storage media.

Moreover, although an example has been described of a case in which the second data is acquired by switching values of the objective variable of the first data between material samples, there is no limitation thereto. For example, the second data may be acquired by another method, as long as it is a method that modifies the value of the objective variable in the first data.

Moreover, the present disclosure is not limited by the above description, and obviously various other modifications may be implemented within a scope not departing from the spirit of the present disclosure.

What is claimed is:

1. An information processing device, comprising
a memory, and
a processor coupled to the memory, wherein the processor is configured to:
perform regression analysis for a plurality of types of a material sample based on first data including a plurality of explanatory variables that are feature values of the material sample and an objective variable that is a performance of the material sample, by performing regression analysis for respective combinations of at least one explanatory variable from among the plurality of explanatory variables, and evaluate error with respect to a result of the regression analysis on the combination;
perform regression analysis for respective combinations of at least one explanatory variable from among the plurality of explanatory variables based on second data that results from modifying a value of the objective variable in the first data for the plurality of types of material sample, and evaluate error with respect to a result of the regression analysis on the combination;
generate a distribution expressing a frequency of combinations of the explanatory variables resulting in respective errors for each of the errors, based on an evaluation result of the error with respect to a regression analysis result with the first data;
generate a distribution expressing a frequency of combinations of the explanatory variables resulting in respective errors for each of the errors, based on an evaluation result of the error with respect to a regression analysis result with the second data; and
output a result of comparing the distributions.

2. The information processing device of claim 1, wherein the processor is further configured to:
determine a significance of the regression analysis result with the first data based on a result of comparing the distributions; and
visualize a magnitude of regression coefficients for each of the explanatory variables obtained as the regression analysis result for each explanatory variable combination in a case in which the regression analysis result with the first data is determined to be significant.

3. The information processing device of claim 2, wherein:
the processor is further configured to receive a selection of at least one explanatory variable; and
the processor further performs regression analysis for a selected combination of at least one explanatory variable and evaluates error with respect to a result of the regression analysis result for the selected combination.

4. An information processing method in which a computer:
performs regression analysis for a plurality of types of a material sample based on first data including a plurality of explanatory variables that are feature values of the material sample and an objective variable that is a performance of the material sample, by performing regression analysis for respective combinations of at least one explanatory variable from among the plurality of explanatory variables, and evaluates error with respect to a result of the regression analysis on the combination;
performs regression analysis for respective combinations of at least one explanatory variable from among the plurality of explanatory variables based on second data that results from modifying a value of the objective variable in the first data for the plurality of types of material sample, and evaluates error with respect to a result of regression analysis on the combination;
generates a distribution expressing a frequency of combinations of the explanatory variables resulting in respective errors for each of the errors, based on an evaluation result of the error with respect to a regression analysis result with the first data;
generates a distribution expressing a frequency of combinations of the explanatory variables resulting in respective errors for each of the errors, based on an evaluation result of the error with respect to a regression analysis result with the second data; and
outputs a result of comparing the distributions.

5. A non-transitory storage medium storing a program that is executable by a computer to perform processing, the processing comprising:
performing regression analysis for a plurality of types of a material sample based on first data including a plurality of explanatory variables that are feature values of the material sample and an objective variable that is a performance of the material sample, by performing regression analysis for respective combinations of at least one explanatory variable from among the plurality of explanatory variables, and evaluating error with respect to a result of the regression analysis on the combination;
performing regression analysis for respective combinations of at least one explanatory variable from among the plurality of explanatory variables based on second data that results from modifying a value of the objective variable in the first data for the plurality of types of material sample, and evaluating error with respect to a result of regression analysis on the combination;
generating a distribution expressing a frequency of combinations of the explanatory variables resulting in respective errors for each of the errors, based on an evaluation result of the error with respect to a regression analysis result with the first data;
generating a distribution expressing a frequency of combinations of the explanatory variables resulting in respective errors for each of the errors, based on an evaluation result of the error with respect to a regression analysis result with the second data; and
outputting a result of comparing the distributions.
